(19) United States
(12) Patent Application Publication
(10) Pub. No.: US 2017/0372047 A1
(43) Pub. Date: Dec. 28, 2017

(54) COMPUTATIONALLY IMPLEMENTED METHOD WITH LOCKDOWN CAPABILITY

(71) Applicant: MALLORY DYER, COOLIDGE, AZ (US)

(72) Inventor: MALLORY DYER, COOLIDGE, AZ (US)

(21) Appl. No.: 15/191,528

(22) Filed: Jun. 24, 2016

(51) Int. Cl. G06F 21/31; G08B 5/36

(52) U.S. Cl. CPC G06F 21/31; G08B 5/36

(57) ABSTRACT

The present invention relates to a computationally implemented method wherein the computationally implemented method enables its use on the user smart device and run on Android/IOS platforms. The present invention enables at least one user to use the computationally implemented method on a smart device and also enables at least one mentor to use the same computationally implemented method at the same time, wherein the use of this computationally implemented method by the mentor enables the mentor to control the computationally implemented method of the user through the lockdown mode. The lockdown mode of the mentor enables him/her to control the computationally implemented method of the user and thus lock the smart device of the user to restrain the user from opening any other application, close out of the computationally implemented method, or receive any notification during the use of the computationally implemented method.

### FIELD OF THE INVENTION

The present invention generally relates to a computationally implemented method designed to operate on user smart device and is also provided with direct accessibility feature with enabled lockdown code and capability.

### BACKGROUND OF THE INVENTION

An electronic calculator is a small, portable electronic device used to perform both basic operations of arithmetic and complex mathematical operations.

In addition to this, calculator is additional educational tool that allows students to reach higher level of mathematical power understanding, reasoning, number sense, and computationally implemented methods. Four function, scientific and graphing calculators as well as calculator with computationally symbolic algebra manipulation capability provide new pedagogical enhancement opportunities. They afford students learning tools that complement, but do not replace, mental and paper and pencil skills and they expand student's ability to solve problems by providing multiple solution techniques.

However, the changes in our economy have greatly impacted the students, many students do not have the funds to purchase a calculator wherein, almost every student that enrolls in college needs a graphing calculator for some or the other course and this graphical calculators used by the students in their problem solving subject is out of the reach of many people. Moreover calculators or the similar devices present in the market is only able to meet the need of a calculator which is able to perform the scientific and arithmetic calculation and is not provided with any additional feature other than this. Although calculators are available in our smart device but is not enabled with a feature which makes them perfect to be used for the school and college's examination purpose neither the smart phones provided with the calculator posses the lock down mode feature wherein the student is enabled only to use the applications been provided by the calculator and do not use any other smart phone feature.

The various smart devices provides number of features wherein these features and application provided in the smart devices are not useful at the time a student is studying wherein all this feature available in these smart devices leads to mind diversion of the student and do not lead them to concentrate on studies. The various application installed on our smart device are sometime time killing and lead to a disturbance when a person is trying to concentrate on his/her work and making use of some useful application of his/her smart device.

Therefore, there remains a need to overcome above mentioned problems and our invention resolve this entire problem.

### SUMMARY OF THE INVENTION

The main objective of the present invention is to overcome the limitations of the prior arts by providing a computationally implemented method designed to operate on user smart device and is also provided with direct accessibility feature with enabled lockdown code and capability.

The present invention of a computationally implemented method enables its use on the user smart device and runs on Android/IOS platforms but not limited to these only. The present invention enables at least one user to use the computationally implemented method on a smart device and also enables at least one mentor to use the same computationally implemented method at the same time, wherein the use of this computationally implemented method by the mentor enables the mentor to control the computationally implemented method of the user through the lockdown mode. The lockdown mode of the mentor enables him/her to control the computationally implemented method of the user and thus lock the smart device of the user to restrain the user from opening any other application, close out of the computationally implemented method, or receive any notification during the use of the computationally implemented method. Therefore, converting the user smart device solely into a computationally implemented method, wherein during the lockdown mode the user cannot exit out the computationally implemented method, cannot call, send text, open other computationally implemented methods, receive new notification, open internet, other social media sites, take pictures and also the user smart device do not make any noise during the lock down mode.

Moreover, the present invention of the computationally implemented method is used by a teacher wherein, the teacher is enabled to create a group of students on the computationally implemented method and then control the use of the computationally implemented method of those groups of students. For this, the teacher is enabled to register on the computationally implemented method, select the students using the computationally implemented method and form a group of selected students on computationally implemented method. The teacher then assigns the group of students a name and a unique code which are generated by the computationally implemented method. The students are registered in the group by two ways wherein, the teacher is either enabled to send the students the unique code to enter the lock down mode and have the student text/email it to a general account or the teacher is enabled to add students manually by entering their email/unique code that is linked with the student's account. Once a student is registered into an account, his/her name appears in black on the roster displayed on the computationally implemented method of the teacher. The teacher then selects the unique ID which appears by the student's name in the roster (in case they have students with the same name). When the teacher wants to add the group of students into lockdown mode, the teacher first selects the group of students and customizes the computationally implemented method. To customize the computationally implemented method, the teacher first click the link which pull up all computationally implemented method functionalities. The teacher is enabled to “X” out any functions he/she does not want the student to use at that time (eventually add date and time range). The teacher then instructs the students to open the computationally implemented method on their smart device and select the “lockdown mode”. The students are prompted to login and enter their email/ID linked to the account. Once the student has logged in, his/her name now appears in green with a check mark next to it on his/her smart device that have a green border on the screen. If a student tries to log out of the lock down mode his/her name go to red with an X by it and the border turn red. As the students are all logging in, the teacher enter the timer and the lockdown code that they have created. Once all students names are in green, the teacher select “enter lockdown code.” When the teacher does this a “starts timer” button appears on the student's device. If the student tried to exit, open another application at this point, their name appear in red with an X, the border on his/her device turn red, and the website/app makes a noise to notify the teacher. If the teacher is controlling it by their own device, it pop up as a notification banner. The student is also not able to have access to the computationally implemented method until he/she actuates “start timer.”

Also, the parent is enabled to create a login/ID for the user, wherein the user is enabled to login using the email/ID created by his/her parent and the user remain in the parent's account until the parent deletes the user from his/her account. Herein, the user name show up in black on the parent's home page and the parent instruct the user to open the computationally implemented method and select “Lockdown Mode” which then prompt the user to login using the account created by the parent. Once the user has done this, his/her name appears in green with a check mark next to it on the computationally implemented method of the parent and the parent is then enabled to enter in a timer with a lockdown code. Once the parent hits “enter lockdown code” the user get a “start timer” option to open the computationally implemented method and a green border appear showing it is in lockdown mode. The parent then unlocks the user device manually, through his/her own computationally implemented method or let the timer run out.

Lastly, in the present invention if a user is in class and the computationally implemented method is in lock down mode, the teacher prompt the user to go to “Lockdown Mode” and the user have to sign in using his/her email/ID (if they have forgotten this, the teacher is enabled to look it up in the class settings). The user is able to change the email linked to the account but cannot change the ID. Once a user logs in, his/her name appears in green with a check mark next to it. If the user tries to open any other application or exit out, his/her name appear in red with an X by it and notify the teacher.

### BRIEF DESCRIPTION OF THE DRAWINGS

The following drawings illustrates exemplary embodiment; however, they are helpful in illustrating objects, features and advantages of the present invention because the present invention will be more apparent from the following detailed description taken in conjunction with accompanying drawings in which:

FIG. 1 illustrates the schematic view of the given invention according to an embodiment of the invention.

### DETAIL DESCRIPTION OF THE INVENTION

Reference will now be made in detail to the exemplary embodiment (s) of the invention, examples of which are illustrated in the accompanying drawings. Whenever possible, the same reference numerals will be used throughout the drawings to refer to the same or like parts.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications, patents and patent computationally implemented methods mentioned herein are incorporated herein in their entirety.

The present invention relates to a computationally implemented method which enables its use on the user smart device and runs on Android/IOS platforms but not limited to these only. The present invention enables at least one user to use the computationally implemented method on a smart device and also enables at least one mentor to use the same computationally implemented method at the same time, wherein the use of this computationally implemented method is for controlling the computationally implemented method of the user through the lockdown mode by the mentor. The lockdown mode of the mentor enables him/her to control the computationally implemented method of the user and thus lock the smart device of the user to restrain the user from opening any other application, close out of the computationally implemented method or receive any notification during the use of the computationally implemented method. Therefore, converting the user smart device solely into a computationally implemented method, wherein during the lockdown mode wherein the user cannot exit out the computationally implemented method, cannot call, send text, open other application, receive new notification, open internet, other social media sites, take pictures and also the user smart device do not make any noise during the lock down mode.

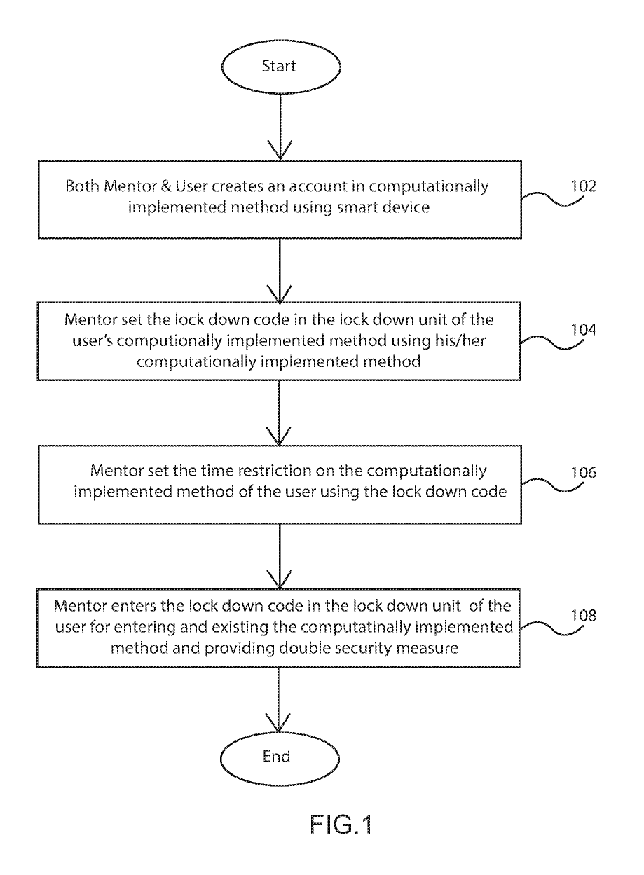

FIG. 1 illustrates the flow chart of computationally implemented method [100] which is the schematic view of the given invention.

STEP.102 of FIG. 1 illustrates creating an account on computationally implemented method for both including at least one of the user and for at least one of the mentor, wherein the user includes the student and the mentor includes the teacher, proctor or the parent of at least one of the user. The teachers, parents, proctors and students get registered on computationally implemented method. A user and a mentor cannot get access to the computationally implemented method until he/she is registered. Each login takes the user and the mentor to a specific page customized for each group for different user. The mentor sign up with an email and creates a username and password. A user login with an email and this generate a unique ID that is alphanumeric and case sensitive. This helps to get the right user into classes, avoid confusion if user has the same name and also ensure the correct user is registering to take the test with the mentor.

STEP.104 of FIG. 1 illustrates setting a lock down code by using a lock down unit, wherein the lock down unit enables entering the lock down code via at least one of a mentor in at least one of a user smart device, wherein when the user smart device is in lockdown mode, it have a green border around it. If at least one of the user using computationally implemented method on his/her smart device tries to exit the computationally implemented method without the mentor permission or tries to open a different application during lockdown mode the border turns red and his/her name turns red with an X by it and also a noise go off to alert at least one of the mentors. The at least one of the mentor is able to make users smart device to work in the lock down mode individually or do a mass lockdown for an entire group of the user through the computationally implemented method. This also enables a user to select one of the individualized lockdown codes and it then prompt the mentor to log in on the device using his/her email/username and password. This prevents friends or those who should not have the ability to lockdown a device from doing so. Only those who are registered have the ability to lockdown a device.

STEP.106 of FIG. 1 illustrates setting a time restriction on the lock down code, wherein the time restriction on the lock down code enables the user smart device to function as the computationally implemented method for the period of time. In the present invention of the computationally implemented method the lock down code provided via lock down unit get expires after a period of the time been allotted by at least one of the mentor on at least one of the user smart device. This further enables its use for the class room purposes and for various examination purposes. For example an computationally implemented method running on the user smart device, wherein the mentor itself sets a lock down code restriction of a time limit for 1 hour and 30 minutes or more and even less, to use during class time or possibly a two hour (or more) restriction limit for exams or to be used in class or in at any work place or at home. The smart device remains in lockdown mode the time runs out, wherein the smart device automatically returns to its normal functionality. While the user smart device is in the lock down mode the name of the user is shown in green with a check mark and there be a green border around the device. If the user attempts to close out of the computationally implemented method or open any other application, his/her name turn red with an X and the border turn red. If the user is not in lock down mode, no border color is displayed around the screen.

STEP.108 of FIG. 1 illustrates entering and exiting of at least one user on the computationally implemented method by at least one mentor using his/her smart device via accessing the lock down code. This process of entering and exiting of at least one user on the computationally implemented method by accessing the lock down code is a double security measures for the computationally implemented method which also enable setting time restriction on the lock down code. Herein, the entry as well as the exit of at least one of the user from the lock down unit is done either by the lock down code or by the timer or date. In case of the entry and exit of the user through lock down code, the user opens the computationally implemented method on his/her smart device wherein, the user enters the computationally implemented method by a lock down code provided by at least one of the mentor and the user is also able to exit the lock down mode by directly entering the lock down code provided by the mentor. In case of the entry and exit of the user through timer, the mentor is enabled to restrict the use of the computationally implemented method via timer wherein, when the timer runs out, the user automatically gets logged out of the computationally implemented method. In case of the entry and exit of the user through date, the mentor is enabled to set a date restriction which enables the user to access the computationally implemented method till the set date and the lock down code gets automatically expired after the set date.

In the preferred embodiment of the present invention the method is been used by a teacher wherein, the teacher is enabled to register on the computationally implemented method, and is also enabled to create a group of students from the class. The teacher provides the group of students a name and a unique code. The students get entered into the group by two ways:
I. the teacher is enabled to send the students a unique code for enabling the lock down mode and have the student text/email it to a general account; or
II. the teacher is enabled to add students manually by entering their email/unique code that is linked with the student's account.
   Once a student is registered into an account, his/her name appears in black on the roster displayed on the computationally implemented method of the teacher. The teacher selects the unique ID appearing by the name of the student in the roster (in case they have students with the same name). When the teacher wants to set the group of students into lockdown mode, the teacher first selects the group of students and customizes the computationally implemented method if he/she chooses to do so. To customize the computationally implemented method, the teacher clicks the link which pull up all computationally implemented method functionalities. The teacher is enabled to “X” out any functions he/she does not want the student to use at that time (eventually add date and time range). The teacher then tells the students to open the computationally implemented method computationally implemented method on their smart device and select the “lockdown mode”. The student then get prompted to log in and enter their email/ID linked to the account. Once the student has logged in, his/her name now appear in green with a check mark next to it and his/her smart device have a green border on the screen. If a student tries to back out at this point, his/her name goes to red with an X by it and the border turn red. As the students are all logging in, the teacher enter the timer and the lockdown code that they create. Once all students names are in green, the teacher select “enter lockdown code.” When the teacher does this a “starts timer” button appears on the student's device. If the student tried to exit, open another application at this point, their name appear in red with an X, the border on his/her smart device turn red, and the website/app make a noise to notify the teacher. If the teacher is controlling it by their own device, it pop up as a notification banner. The student also not able to have access to the computationally implemented method until he/she actuates “start timer.”

In other embodiment of the present invention if a student is in class and the computationally implemented method is in lock down mode, the teacher prompts the student to go to “Lockdown Mode” and the student have to sign in using his/her email/ID (if they have forgotten this, the teacher is enabled to look it up in the class settings). The student is able to change the email linked to the account but cannot change the ID. Once a student logs in, his/her name appears in green with a check mark next to it and if he/she tries to open any other application or exit out his/her name appear in red with an X by it and notify the teacher.

In another embodiment of the present invention, the parent is enabled to create a login/ID for the user, wherein the user is enabled to login using the email/ID created by his/her parent and the user remain in the parent's account until the parent deletes the user from his/her account. Herein, the user name show up in black on the parent's home page and the parent instruct the user to open the computationally implemented method and select “Lockdown Mode” which then prompt the user to login using the account created by the parent. Once the user has done this, his/her name appears in green with a check mark next to it on the computationally implemented method of the parent and the parent is then enabled to enter in a timer with a lockdown code. Once the parent hits “enter lockdown code” the user get a “start timer” option to open the computationally implemented method and a green border appear showing it is in lockdown mode. The parent then unlocks the user device manually, through his/her own computationally implemented method or let the timer run out.

While the invention has been described in detail with specific reference to preferred embodiments thereof, it is understood that variations and modifications thereof may be made without departing from the true spirit and scope of the invention.

What is claimed is:

1- A computationally implemented method comprising:
a. setting a lock down code, by using a lock down unit, enabled on a computer or smart device, wherein the lock down unit enables entering the lock down code via at least one of a mentor in a smart device of at least one of a user;
b. setting a time restriction on the lock down code, wherein the time restriction on the lock down code enables the user smart device to function as the computationally implemented method for the period of time; and
c. exiting the lock down unit, wherein the exit through the lock down unit is enabled by entering the lock down code.

2- The method in claim 1; wherein the computationally implemented method do not allow any incoming calls, texts, emails or push notifications on the user smart device.

3- The method in claim 1; wherein after entering the lock down code there appears a notification enabling at least one of the mentor to know about a current status of at least one of the user.

4- The method in claim 1; wherein an alert system enables at least one of the mentors to know about the activity of at least one the user.

5- The method in claim 1; wherein the computationally implemented method implements automatic and manual date restriction for the usage of the computationally implemented method by at least one of the user or by at least one of the mentor.

6- The method in claim 1; wherein the computationally implementation method further enables automatic deletion of history of at least one of the user wherein the deletion is either enabled by at least one of the mentor or at least one of the user.

7- The method in claim 1; wherein the computationally implemented method providing number of data mining options is to be accessed by at least one of the user or by at least one of the mentor, wherein the data mining options enable showing the usage of the computationally implemented method and its features to indicate statistics on the performance of the users.

8- The method in claim 1; wherein the computationally implemented method further provides variations like English dictionary, calculator, formula sheets and options for various subjects to at least one of the user and to at least one of the mentor.

9- The method in claim 1; wherein the computationally implemented method is provided with zoom in and zooms out feature.

10- The method in claim 1; wherein the lock down code created further comprises individual and mass lock down code feature.

11- A computationally implemented method comprising:
a. setting a lock down code by using a lock down unit, wherein the lock down unit enables entering the lock down code via at least one of a mentor in at least one of a user smart device;
b. setting a time restriction on the lock down code, wherein the time restriction on the lock down code enables the user smart device to function as the computationally implemented method for the period of time; and
c. providing a double security measures, wherein the double security enables the entry and exit through the lock down unit by enabling time restriction on the lock down code.

12- The method in claim 11; wherein the computationally implemented method do not allow any incoming calls, texts, emails or push notifications on the user smart device.

13- The method in claim 11; wherein after entering the lock down code there appears a notification enabling at least one of the mentor to know about a current status of at least one of the user.

14- The method in claim 11; wherein an alert system enables at least one of the mentors to know about the activity of at least one the user.

15- The method in claim 11; wherein the computationally implemented method implements automatic and manual date restriction for the usage of the computationally implemented method by at least one of the user or by at least one of the mentor.

16- The method in claim 11; wherein the computationally implementation method further enables automatic deletion of history of at least one of the user wherein the deletion is either enabled by at least one of the mentor or at least one of the user.

17- The method in claim 11; wherein the computationally implemented method providing number of data mining options is to be accessed by at least one of the user or by at least one of the mentor.

18- The method in claim 11; wherein the computationally implemented method further provides variations like English dictionary, calculator, formula sheets and options for various subjects to at least one of the user and to at least one of the mentor.

19- The method in claim 11; wherein the computationally implemented method is provided with zoom in and zooms out feature.

20- The method in claim 11; wherein the lock down code created further comprises individual and mass lock down code feature.
